(19) United States
(12) Patent Application Publication
(10) Pub. No.: US 2004/0163685 A1
(43) Pub. Date: Aug. 26, 2004

(54) Nozzle assembly of dishwasher

(76) Inventor: Hee Seok Roh, Changwon-shi (KR)

Correspondence Address: FLESHNER & KIM, LLP, P.O. BOX 221200, CHANTILLY, VA, 20153, US

(21) Appl. No.: 10/721,737

(22) Filed: Nov. 26, 2003

(30) Foreign Application Priority Data
Nov. 28, 2002 (KR) P2002-0074991

(51) Int. Cl. B08B 3/00

(52) U.S. Cl. 134/58 D; 134/176; 134/179; 134/200

(57) ABSTRACT

A nozzle assembly of a dishwasher enables injection holes of a top nozzle to selectively face a top or bottom rack to spray water toward the bottom rack when items to be washed are loaded on the bottom rack only. The nozzle assembly includes a first and second nozzles, rotatably installed adjacent first and second racks, respectively, for selectively spraying water in first and second directions. The first nozzle includes a device for manually setting the spraying direction. The first nozzle also includes a fixed central piece, communicating with a water circulator, having two open ends; and first and second nozzle sections, communicating with the fixed central piece and each having a closed end and an open end, the closed end of each nozzle section being rotatably coupled to one open end of the fixed central piece. The first and second nozzle sections are rotated using the manual setting device.

This application claims the benefit of Korean Application No. 10-2002-0074991 filed on Nov. 28, 2002, which is hereby incorporated by reference.

### BACKGROUND OF THE INVENTION

1. Field of the Invention

The present invention relates to a dishwasher, and more particularly, to a nozzle assembly of a dishwasher having top and bottom racks, employing a top nozzle having reversible nozzle pieces enabling the selective spraying of water toward the top or bottom rack according to a manual setting of the top nozzle by the user.

2. Discussion of the Related Art

Generally speaking, a dishwasher is provided with a water circulation means actuated by a wash pump installed in a bottom compartment of the dishwasher. Thus, the washing of a number of items, such as tableware and the like, is performed by spraying washing water onto the items, which are placed on one or more racks to be washed, and the spaying action is achieved by at least one nozzle rotating under the force of the wash pump. That is, a dishwasher for the efficient washing of a large number of items simultaneously is typically provided with top and bottom racks and a nozzle assembly comprising top and bottom nozzles respectively dedicated for spraying water toward the corresponding rack. Each nozzle communicates with the water circulating means via one of two injection passages for simultaneously transmitting the water from the wash pump to a plurality of injection holes formed in the nozzles. Such a dishwasher is shown in FIG. 1, with a top nozzle of the nozzle assembly detailed in FIG. 2.

Referring to FIGS. 1 and 2, a dishwasher having a nozzle assembly according to a related art is comprised of a washtub 4 installed in a body 2 to have upper and lower spaces for washing items; top and bottom racks 8 and 9, slidably installed in the upper and lower spaces of the washtub, for holding a number of items to be washed; a top nozzle 12, rotatably installed under the top rack, for spraying water upward onto the top rack through a plurality of injection holes 12h provided on an upper surface; and a bottom nozzle 14, rotatably installed under the bottom rack, for spraying water upward onto the bottom rack through a plurality of injection holes 14h provided on an upper surface. The top and bottom nozzles 12 and 14 each communicate separately with the water circulating means via top and bottom injection passages 26 and 28, respectively.

The above-described dishwasher having a nozzle assembly according to the related art may be operated at capacity by placing a large number of items to be washed in both racks, but when operating the dishwasher at less then maximum capacity, the items to be washed may only fill one rack, for example, the bottom rack. Therefore, in using such a dishwasher at some capacity less than maximum, where items are placed in the bottom rack only, the simultaneous operation of both nozzles wastes water and energy, since the injection holes of the top nozzle are fixed to face the top rack and thus spray water onto an empty top rack.

### SUMMARY OF THE INVENTION

Accordingly, the present invention is directed to a nozzle assembly of a dishwasher that substantially obviates one or more of the problems due to limitations and disadvantages of the related art.

An object of the present invention, which has been devised to solve the foregoing problem, lies in providing a nozzle assembly of a dishwasher, which enables injection holes of a top nozzle to face a top or bottom rack selectively, to spray water toward either rack.

It is another object of the present invention to provide a nozzle assembly of a dishwasher having top and bottom racks, which enables an enhanced washing performance for reduced-capacity loads.

It is another object of the present invention to provide a nozzle assembly of a dishwasher having top and bottom racks, which enables a shorter washing time for reduced-capacity loads.

Additional features and advantages of the invention will be set forth in the description which follows, and in part will be apparent to those having ordinary skill in the art upon examination of the following or may be learned from a practice of the invention. The objectives and other advantages of the invention will be realized and attained by the subject matter particularly pointed out in the specification and claims hereof as well as in the appended drawings.

To achieve these objects and other advantages in accordance with the present invention, as embodied and broadly described herein, there is provided a nozzle assembly of a dishwasher having first and second racks for holding items to be washed, the nozzle assembly including a first nozzle, rotatably installed adjacent the first rack, for selectively spraying water in first and second directions. The first nozzle comprises means for manually setting the spraying direction of the first nozzle.

It is to be understood that both the foregoing explanation and the following detailed description of the present invention are exemplary and illustrative and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional view of a dishwasher having a nozzle assembly according to a related art;

FIG. 2 is a cross-sectional view of the top nozzle of the dishwasher of FIG. 1;

FIG. 3 is a cross-sectional view of a dishwasher having a nozzle assembly according to the present invention;

FIG. 4 is a cross-sectional view of the top nozzle of the dishwasher of FIG. 3;

FIG. 5 is a breakaway view of the top nozzle as shown in FIG. 4; and

FIGS. 6 and 7 are cross-sectional views of a dishwasher having a nozzle assembly according to the present invention, illustrating user-selected operational states of the dishwasher.

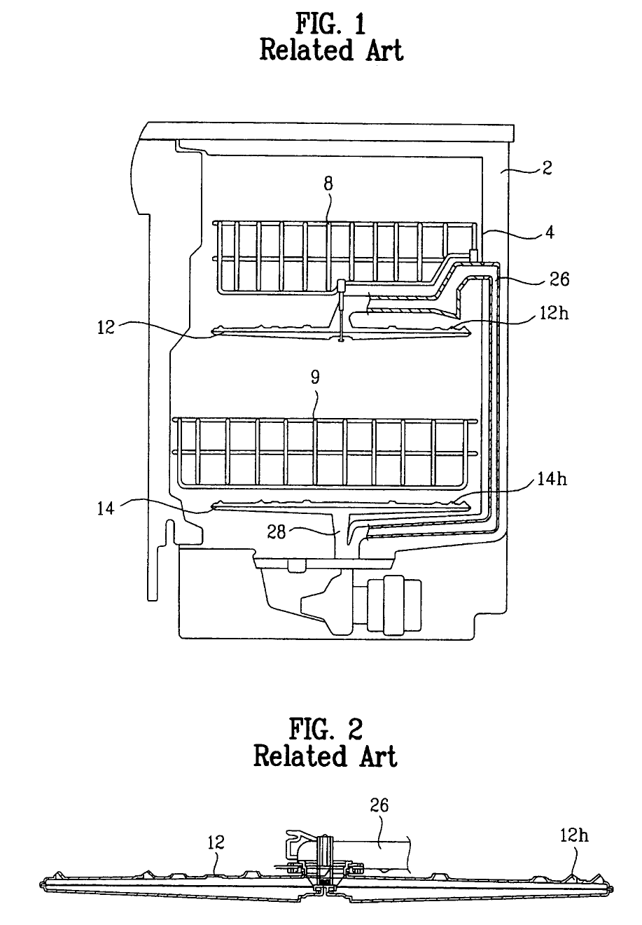

### DETAILED DESCRIPTION OF THE PREFERRED EMBODIMENT

Reference will now be made in detail to the preferred embodiment of the present invention, examples of which are illustrated in the accompanying drawings. Throughout the drawings, like elements are indicated using the same or similar reference designations where possible.

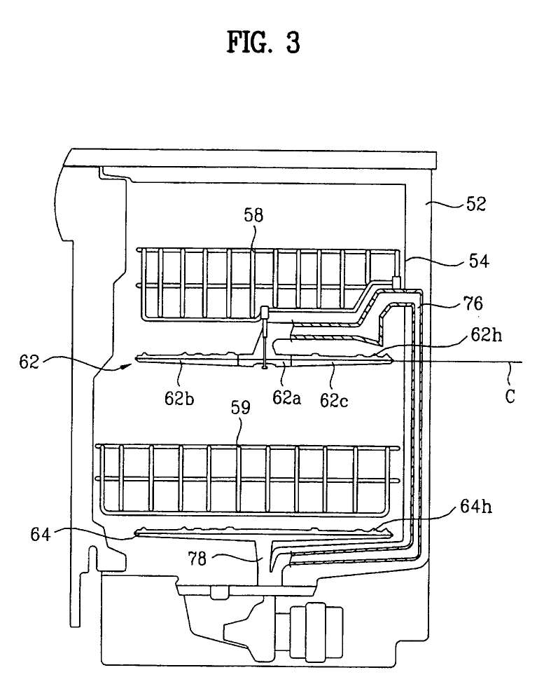

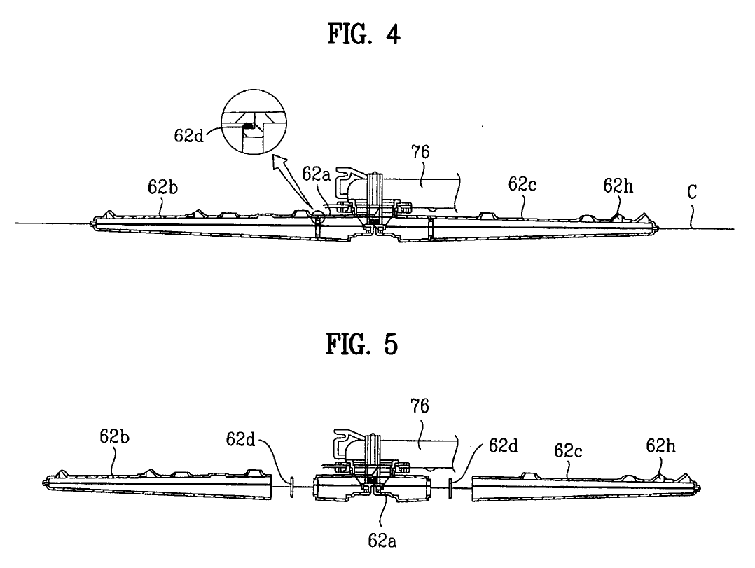

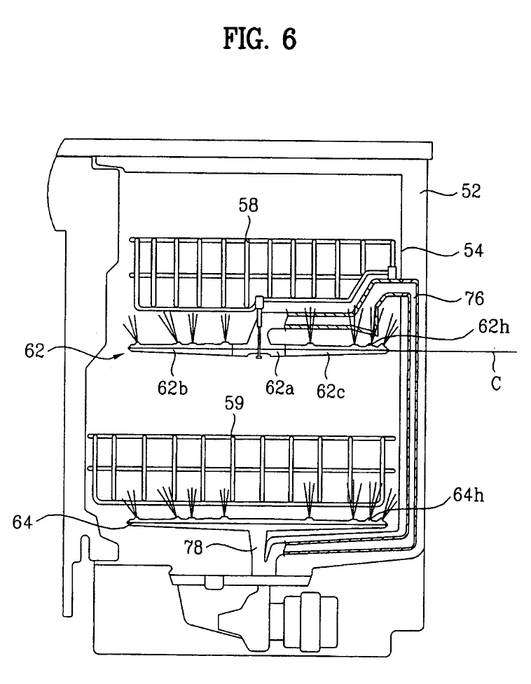

Referring to FIGS. 3-5, a dishwasher having a nozzle assembly according to the present invention is comprised of a washtub 54 installed in a body 52 to have upper and lower spaces for washing items; top and bottom racks 58 and 59, slidably installed in the upper and lower spaces of the washtub, for holding a number of items to be washed; a top nozzle 62, rotatably installed under the top rack, for spraying water toward the items to be washed through a plurality of injection holes 62h provided on a side surface; and a bottom nozzle 64, rotatably installed under the bottom rack, for spraying water upward onto the bottom rack through a plurality of injection holes 64h provided on an upper surface. The top and bottom nozzles 12 and 14 each communicate separately with the water circulating means via top and bottom injection passages 76 and 78, respectively.

According to the present invention, the top nozzle 62 is provided with a means for manually setting a spraying direction, toward items placed in the top rack 58 or the bottom rack 59, by selecting one of two configurations of the top nozzle. To accomplish this, the top nozzle 62 comprises a fixed central piece 62a communicating with the top injection passage 76 and having open ends and first and second nozzle sections 62b and 62c each having an open end which is rotatably coupled to each end of the fixed central piece. The open ends of the first and second nozzle sections 62b and 62c are respectively fitted into the corresponding end of the fixed central piece 62a, allowing a 180° rotation about an axis C of the top nozzle. Thus, the first and second nozzle sections 62b and 62c communicate with the top injection passage 76 via the fixed central piece 62a, and the plurality of injection holes 62h provided on the side surface of the top nozzle 62 are equally distributed on the rotatable first and second nozzle sections, so that water may be selectively directed toward the top or bottom rack 58 or 59 by manually rotating the first and second nozzle sections.

The above selective rotation of the first and second nozzle sections 62b and 62c is enabled by a symmetrical formation, about a horizontal plane passing through the axis C, of the connecting surfaces between the fixed central piece 62a and the first and second nozzle sections 62b and 62c. The open ends of the central part 62a are each stepped, and the inner diameter dimension of the first and second nozzle sections 62b and 62c is greater than an outer diameter of the stepped surface of the open ends of the fixed central piece 62a. Meanwhile, the top nozzle 62 further comprises a pair of rubber based O-rings 62d installed at the connecting surfaces between the fixed central piece 62a and the first and second nozzle sections 62b and 62c, to secure their setting while preventing water leakage during operation. In fitting the O-rings 62d to the top nozzle 62, one O-ring is forcibly fitted over each stepped end of the fixed central piece 62a.

FIG. 6 illustrates an operational state of a dishwasher having the above nozzle assembly according to the present invention, in which the dishwasher is operated at capacity; that is, items to be washed are loaded on both racks. In this case, the user selects a first configuration by rotating the first and second nozzle sections 62b and 62c of the top nozzle 62 with respect to the fixed central piece 62a, to direct the spraying water toward the top rack 58.

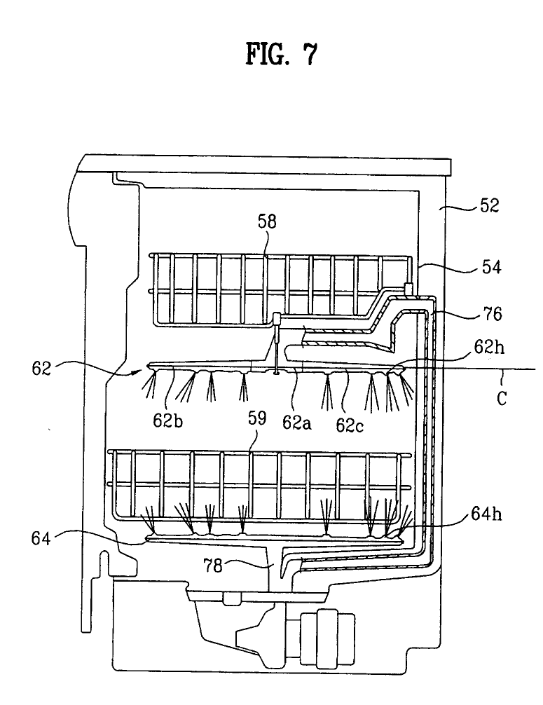

FIG. 7 illustrates an operational state of a dishwasher having the above nozzle assembly according to the present invention, in which the dishwasher is operated at a reduced capacity. In this case, the items to be washed are loaded on the bottom rack only. Therefore, the user selects a second configuration by rotating the first and second nozzle sections 62b and 62c of the top nozzle 62 with respect to the fixed central piece 62a, to direct the spraying water downward to the bottom rack 59. In doing so, the washing time of the reduced-capacity load is shortened while providing enhanced washing performance.

The first and second nozzle sections 62b and 62c are preferably ganged together, such that a twisting action applied to one nozzle will rotate both, in unison, with respect to the fixed central piece 62a.

Accordingly, in a dishwasher adopting the nozzle assembly according to the present invention, the first and second nozzle sections having injection holes formed in one side of each section are rotatably installed on the ends of the fixed central piece, enabling the selective directional positioning of the nozzle assembly's top nozzle to accommodate large- and small-capacity loads as necessary, thereby shortening a washing time, improving a washing performance, and saving water and energy.

It will be apparent to those skilled in the art that various modifications and variations can be made in the present invention without departing from the spirit or scope of the invention. Thus, it is intended that the present invention cover such modifications and variations, provided they come within the scope of the appended claims and their equivalents.

What is claimed is:

1. A nozzle assembly of a dishwasher having first and second racks for holding items to be washed, the nozzle assembly including:
a first nozzle, rotatably installed adjacent the first rack, for selectively spraying water in first and second directions, said first nozzle comprising:
means for manually setting the spraying direction of said first nozzle.

2. The nozzle assembly as claimed in claim 1, further comprising a water circulating means, communicating with said first nozzle, for supplying under pressure the water to be sprayed and for rotating said first nozzle by the pressure of the supplied water.

3. The nozzle assembly as claimed in claim 2, said first nozzle further comprising:
a fixed central piece, communicating with said water circulating means, having two open ends; and
first and second nozzle sections, communicating with said fixed central piece and each having a closed end and an open end, the closed end of each nozzle section being rotatably coupled to one open end of said fixed central piece.

4. The nozzle assembly as claimed in claim 3, wherein said first and second nozzle sections are rotated using said manual setting means.

5. The nozzle assembly as claimed in claim 3, wherein said fixed central piece and said first and second nozzle sections are symmetrical about a horizontal plane passing through the axis of said first nozzle.

6. The nozzle assembly as claimed in claim 3, wherein one of said first and second nozzle sections is rotatable by a manipulation of the other.

7. The nozzle assembly as claimed in claim 3, said top nozzle further comprising a pair of O-rings respective installed at connecting surfaces between said fixed central piece and said first and second nozzles.

8. The nozzle assembly as claimed in claim 7, wherein the open ends of said fixed central piece each have a stepped surface for receiving one of said pair of O-rings.

9. The nozzle assembly as claimed in claim 7, wherein said pair of O-rings are made of a rubber based material for preventing water leakage at the connecting surfaces and for resisting rotation during operation of the nozzle assembly.

10. The nozzle assembly as claimed in claim 1, further comprising a second nozzle, rotatably installed adjacent the second rack, for directing water toward the second rack.

11. The nozzle assembly as claimed in claim 10, further comprising a water circulating means, communicating with said second nozzle, for supplying under pressure the water to be sprayed and for rotating said second nozzle by the pressure of the supplied water.

12. The nozzle assembly as claimed in claim 10, wherein the first and second racks are top and bottom racks, respectively, and said first and second nozzles are top and bottom nozzles, respectively.

13. The nozzle assembly as claimed in claim 10, wherein said first and second nozzles are disposed parallel to the first and second racks, respectively.

14. The nozzle assembly as claimed in claim 1, wherein said first nozzle consists of two sides and wherein a plurality of injection holes and formed on one side to spray water in one direction.

15. The nozzle assembly as claimed in claim 1, wherein said manual setting means provides for a 180° rotation about an axis of said first nozzle.
